(19) United States
(12) Patent Application Publication
(10) Pub. No.: US 2016/0117870 A1
(43) Pub. Date: Apr. 28, 2016

(54) VEHICLE INFORMATION ACQUISITION METHOD AND DEVICE

(71) Applicant: LAUNCH TECH COMPANY LIMITED, Guangdong (CN)

(72) Inventors: Jun LIU, Shenzhen, Guangdong (CN); Hongwei SUN, Shenzhen, Guangdong (CN)

(73) Assignee: LAUNCH TECH COMPANY LIMITED, Shenzhen, Guangdong (CN)

(21) Appl. No.: 14/894,173

(22) PCT Filed: Dec. 6, 2013
(86) PCT No.: PCT/CN2013/088705

§ 371 Date: Nov. 25, 2015

(30) Foreign Application Priority Data
Aug. 7, 2013 (CN) 201310342765.9

(51) Int. Cl. G07C 5/08; G07C 5/12; G07C 5/00

(52) U.S. Cl. CPC G07C 5/0808; G07C 5/008; G07C 5/0841; G07C 5/12

(57) ABSTRACT

A vehicle information acquisition method and device: a diagnostic device collects vehicle information; and a mobile intelligent terminal is able to be in communication with the diagnostic device via a WLAN, and accesses the diagnostic device via a webpage to acquire the vehicle information displayed on the webpage. Thus, a user can acquire vehicle driving information in real time simply by utilizing the mobile intelligent terminal to access a WLAN. The present invention is more convenient to use and is applied in a wider range compared with the vehicle information acquisition method in the prior art.

### CROSS REFERENCE OF RELATED APPLICATION

This application claims the priority to Chinese Patent Application No. 201310342765.9, titled “VEHICLE INFORMATION ACQUISITION METHOD AND DEVICE” and filed on Aug. 7, 2013 with the State Intellectual Property Office of China, which is hereby incorporated by reference in its entirety.

### FIELD

The disclosure relates to the technical field of on-board control applications, and in particular to a vehicle information acquisition method and a vehicle information acquisition device.

### BACKGROUND

With the rapid development of the automotive industry, demand for on-board electronic products keeps growing. Various vehicle electronic products in large numbers have appeared on the market. Vehicle failure diagnostic systems have developed over the years and become prevalent on the market. Vehicle failure diagnostic systems for individual customers, which are designed to be compact, convenient to operate, and cost-effective, have been made commercially available. The personal vehicle failure diagnostic system performs diagnoses based on On-Board Diagnostics (OBD) and is in general application. Therefore, the vehicle failure diagnostic systems for individual customers gradually enter personal vehicle markets.

Currently, most vehicle failure diagnostic systems commercially available are connected with display screens via wiring harnesses and diagnostic information of the vehicle is displayed on the display screen in real time. Obviously, display screens connected with such vehicle failure diagnostic systems via wiring harnesses can be used only within a certain range of distance. The user may feel inconvenient when reading vehicle traveling information. Further, although some high-end vehicle failure diagnostic systems are equipped with Bluetooth functions, and can transmit the vehicle traveling information to mobile smart terminals equipped with Bluetooth functions, to facilitate data reading by the user, less and less mobile smart terminals are equipped with Bluetooth functions, which limits the usage of vehicle failure diagnostic systems.

The applicant has found during research and practice on vehicle failure diagnostic systems that, a conventional vehicle failure diagnostic system can display the vehicle information on the mobile smart terminal only through wired transmission, or the mobile smart terminal needs to be Bluetooth enabled to receive the vehicle information from the vehicle failure diagnostic system. Therefore, the conventional failure diagnostic system is inconvenient to use and poor in general application.

### SUMMARY

A vehicle information acquisition method and a vehicle information acquisition device are provided according to the embodiments of the disclosure to enable a mobile smart terminal to obtain vehicle information via a wireless local area network WLAN, thus a user may obtain information of the vehicle in real time. The vehicle information acquisition method and the vehicle information acquisition device provided according to the embodiments of the disclosure are convenient in broad applicability.

In view of this, a vehicle information acquisition method and a vehicle information acquisition device are provided according to the embodiments of the disclosure.

A vehicle information acquisition method includes:

collecting vehicle information by a diagnostic device, where the diagnostic device is provided with a wireless local area network WLAN module for transmitting a WLAN signal; and

accessing the diagnostic device by a mobile smart terminal via a webpage, where the diagnostic device and the mobile smart terminal are in communication connection via the WLAN, and the vehicle information is displayed on the webpage.

A vehicle information acquisition device includes:

a diagnostic device configured to collect vehicle information, where the diagnostic device is provided with a wireless local area network WLAN module for transmitting a WLAN signal; and

a mobile smart terminal in communication connection with the diagnostic device via the WLAN, wherein the mobile smart terminal is configured to access the diagnostic device via a webpage, and the vehicle information is displayed on the webpage.

A vehicle information acquisition method and a vehicle information acquisition device are provided according to the embodiments of the disclosure. A diagnostic device collects vehicle information. A mobile smart terminal can communicate with the diagnostic device via a WLAN, and access the diagnostic device via a webpage to obtain the vehicle information displayed on the webpage. Thus, a user can obtain vehicle traveling information in real time by accessing the WLAN with a mobile smart terminal. As compared with a conventional vehicle information acquisition method, the vehicle information acquisition method and the vehicle information acquisition device provided are more convenient in usage and are more widely applicable.

### BRIEF DESCRIPTION OF THE DRAWINGS

Drawings for the description of embodiments are described briefly as follows, so that technical solutions according to the embodiments of the present disclosure can become clearer. Apparently, the drawings in the following description merely illustrate a few embodiments of the present disclosure. For those skilled in the art, other drawings may be obtained based on these drawings without any creative work.

FIG. 1 is a flow chart of a vehicle information acquisition method according to an embodiment of the disclosure;

FIG. 2 is a flow chart of a vehicle information acquisition method according to another embodiment of the disclosure;

FIG. 3 is a schematic structural diagram of a vehicle information acquisition device according to an embodiment of the disclosure;

FIG. 4 is a schematic structural diagram of a vehicle information acquisition device according to another embodiment of the disclosure; and

FIG. 5 is a schematic structural diagram of a mobile smart terminal according to an embodiment of the disclosure.

### DETAILED DESCRIPTION OF THE EMBODIMENTS

According to the embodiments of the disclosure, a vehicle information acquisition method and a vehicle information acquisition device are provided to enable a mobile smart terminal to acquire vehicle information via a wireless local area network WLAN, and thus a user can acquire the vehicle information in real time. The vehicle information acquisition method and the vehicle information acquisition device provided according to the embodiments of the disclosure are convenient in usage and widely applicable.

In order for clarity and better understanding of the above objects, features and advantages of the present disclosure, technical solutions according to the embodiments of the present disclosure are described clearly and completely hereinafter in conjunction with the drawings. It is apparent that the described embodiments are merely a few rather than all embodiments according to the present disclosure. Any other embodiments obtained by those skilled in the art based on the embodiments in the present disclosure without any creative work fall in the protection scope of the present disclosure.

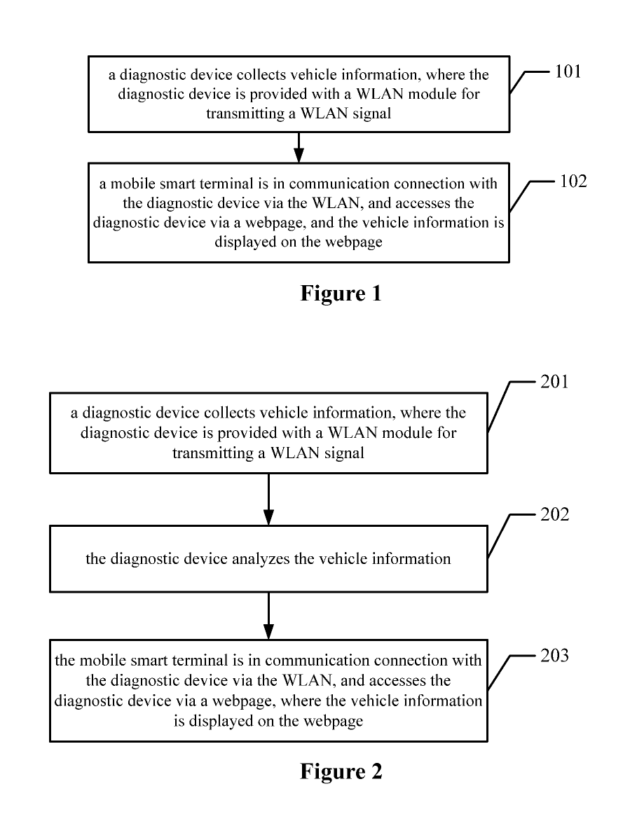

Referring to FIG. 1, a flow chart of a vehicle information acquisition method according to an embodiment of the disclosure is shown. As shown in FIG. 1, the vehicle information acquisition method according to the embodiment of the disclosure may include the following steps 101 and 102.

In step 101, a diagnostic device collects vehicle information, where the diagnostic device is provided with a WLAN module for transmitting a WLAN signal.

In step 102, a mobile smart terminal is in communication connection with the diagnostic device via the WLAN, and accesses the diagnostic device via a webpage, and the vehicle information is displayed on the webpage.

A vehicle information acquisition method is provided according to the present embodiment. A diagnostic device collects vehicle information, and a mobile smart terminal may communicate with the diagnostic device via the WLAN, and access the diagnostic device via a webpage to obtain the vehicle information displayed on the webpage. Therefore, the user may obtain vehicle traveling information in real time by accessing the WLAN network with a mobile smart terminal. As compared with a conventional vehicle information acquisition method, the vehicle information acquisition method and the vehicle information acquisition device provided are more convenient in usage and more widely applicable.

Referring to FIG. 2, a flow chart of a vehicle information acquisition method according to another embodiment of the disclosure is shown. As shown in FIG. 2, the vehicle information acquisition method according to the embodiment of the disclosure may include the following steps 201 to 203.

In step 201, a diagnostic device collects vehicle information, where the diagnostic device is provided with a WLAN module for transmitting a WLAN signal.

Optionally, the step 201 in the present embodiment may include: collecting vehicle traveling information and vehicle diagnostic trouble code information. The vehicle traveling information may include vehicle mileage, a driving speed, an amount of fuel stored in the vehicle, a vehicle engine speed, a temperature, a battery voltage, a steering angle, a pressure and the like.

Optionally, an electronic control unit (ECU) is provided on a diagnostic holder of the vehicle. The vehicle traveling information and the vehicle diagnostic trouble code information may be obtained by reading a data stream on a bus of the ECU. Step 201 in the present embodiment may include: reading the vehicle information by the diagnostic device via an OBD interface.

In step 202, the diagnostic device analyzes the vehicle information.

In step 203, the mobile smart terminal is in communication connection with the diagnostic device via the WLAN, and accesses the diagnostic device via a webpage, where the vehicle information is displayed on the webpage.

The mobile smart terminal may include a mobile terminal such as a cell phone or a computer provided with a WLAN access capability.

In the embodiment of the disclosure, the accessing the diagnostic device by the mobile smart terminal via a webpage includes:

accessing, with the mobile smart terminal, the diagnostic device by entering an IP address of the diagnostic device in an address bar of a browser on the mobile smart terminal.

When a user needs to obtain the vehicle traveling information, the user may access the WLAN with a mobile smart terminal such as a cell phone or a computer and visit a webpage to obtain the vehicle information displayed on the webpage. For example, the user may enter “192.168.1.1” on the cell phone, and a webpage with the vehicle information will be displayed on the screen of the mobile smart terminal. The user can view the vehicle information in real time by visiting the webpage with the mobile smart terminal, and thus monitors traveling conditions of the vehicle.

A vehicle information acquisition method is provided according to the present embodiment. A diagnostic device collects vehicle information, and a mobile smart terminal may communicate with the diagnostic device via the WLAN, and access the diagnostic device via a webpage to obtain the vehicle information displayed on the webpage. Therefore, the user may obtain vehicle traveling information in real time by accessing the WLAN with a mobile smart terminal. As compared with a conventional vehicle information acquisition method, the vehicle information acquisition method and the vehicle information acquisition device are more convenient in usage and are more widely applicable.

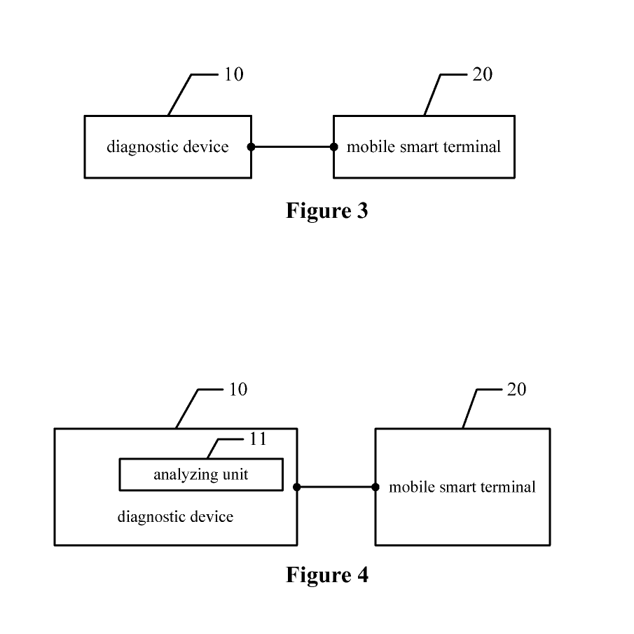

Referring to FIG. 3, a schematic structural diagram of a vehicle information acquisition device according to an embodiment of the disclosure is shown. As shown in FIG. 3, a vehicle information acquisition device may include:

a diagnostic device 10 configured to collect vehicle information, where the diagnostic device is provided with a wireless local area network WLAN module for transmitting a WLAN signal; and

a mobile smart terminal 20 in communication connection with the diagnostic device via the WLAN, where the mobile smart terminal is configured to access the diagnostic device via a webpage, and the vehicle information is displayed on the webpage.

A vehicle information acquisition device is provided according to the present embodiment. A diagnostic device collects vehicle information, and a mobile smart terminal may communicate with the diagnostic device via the WLAN, and access the diagnostic device via a webpage to obtain the vehicle information displayed on the webpage. Therefore, the user can obtain vehicle traveling information in real time by accessing the WLAN network with a mobile smart terminal. As compared with a conventional vehicle information acquisition method, the vehicle information acquisition method and the vehicle information acquisition device provided are more convenient in usage and are more widely applicable.

Referring to FIG. 4, a schematic structural diagram of a vehicle information acquisition device according to another embodiment of the disclosure is shown. As shown in FIG. 4, a vehicle information acquisition device according to the embodiment of the disclosure includes the diagnostic device 10 and the mobile smart terminal 20 of the embodiment shown in FIG. 3.

In the embodiment of the disclosure, the diagnostic device 10 may include:

an analyzing unit 11 configured to analyze the collected vehicle information.

Optionally, the analysis may include: analyzing and classifying keywords in data frames from a vehicle ECU, such as a key word representing the driving speed or a key word representing the vehicle engine speed, according to a vehicle bus protocol, performing a mathematical operation such as addition, subtraction, multiplication, and division on the key words in accordance with an algorithm of a manufacturer, and obtaining corresponding vehicle traveling data.

The mobile smart terminal 20 may obtain the data processed by the analyzing unit 11. The mobile smart terminal 20 is in communication connection with the diagnostic device via the WLAN. A user may visit the webpage with a general mobile smart terminal to view the vehicle information displayed on the webpage. For example, the user may input a webpage address such as “192.168.1.1” in an address bar of a browser on the mobile smart terminal to obtain a webpage with the vehicle driving information such as vehicle traveling information and vehicle diagnostic trouble code information. Thus the user can view the desired vehicle information.

In the present embodiment of the disclosure, the diagnostic device 10 may be further configured to read the vehicle information via an OBD interface.

In the present embodiment of the disclosure, the diagnostic device 10 may be further configured to collect vehicle traveling information and vehicle diagnostic trouble code information.

The mobile smart terminal is in communication connection with the diagnostic device via the WLAN, and accesses the diagnostic device by entering an IP address of the diagnostic device in an address bar of a browser on the mobile smart terminal.

Optionally, the vehicle information acquisition device in this embodiment may integrate a large scale switching circuit and a controller area network (CANBUS) signal transceiver. An internal switch array of the vehicle information acquisition device is connected with diagnostic pins of the diagnostic holder of the vehicle to transmit the vehicle information. Data from the ECU bus of the diagnostic holder of the vehicle may be read with the CANBUS signal transceiver. It should be noted that, functional circuit modules such as the large scale switching circuit and the CANBUS signal transceiver provided in the embodiment of the disclosure are merely examples to further describe the embodiments of the disclosure, and are not to limit the present disclosure.

The vehicle information acquisition device provided according to the present embodiment may be adapted to vehicles supporting KWP (Keyword Protocol 2000, an on-board diagnostic standard widely used in European in the automotive field) and controller area network (CAN) communication protocol, and may also be adapted to vehicles supporting other communication protocols, which are merely examples and not to limited the present disclosure.

The vehicle information acquisition device according to the embodiment of the disclosure may further include a power supply module which may be a power management circuit configured to supply power to the above functional units or modules.

A vehicle information acquisition device is provided according to the present embodiment. A diagnostic device collects vehicle information, and a mobile smart terminal may communicate with the diagnostic device via the WLAN, and access the diagnostic device via a webpage to obtain the vehicle information displayed on the webpage. Thus, the user can obtain vehicle traveling information in real time by accessing a WLAN network with the mobile smart terminal. As compared with a conventional vehicle information acquisition method, the vehicle information acquisition method and the vehicle information acquisition device are more convenient in usage and are more widely applicable.

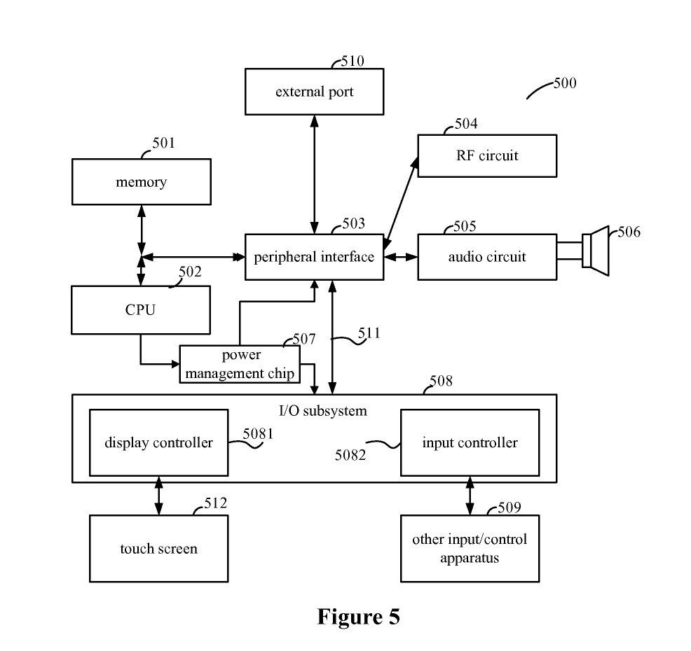

A mobile smart terminal is provided according to a fifth embodiment of the disclosure. Referring to FIG. 5, the mobile smart terminal is the mobile smart terminal described in the embodiments as shown in FIG. 3 and FIG. 4.

It can be understood that the mobile smart terminal 500 shown in the drawings is just an example. A mobile smart terminal may include more or less components than those of the mobile smart terminal 500 as shown in FIG. 5. Two or more components may be integrated. Configuration of the components or may be different. Components shown in the drawings may be implemented in hardware, software or a combination of both hardware and software, including one or more signal processing and/or specific integrated circuits.

The embodiment will be described in detail by taking the mobile smart terminal 500 as an example. FIG. 5 is a schematic structural diagram of a mobile smart terminal for acquiring vehicle information according to an embodiment of the disclosure. As shown in FIG. 5, the mobile smart terminal 500 includes: a memory 501, a central processing unit (CPU) 502, a peripheral interface 503, an RF circuit 504, an audio circuit 505, a speaker 506, a power management chip 507, an input/output (I/O) subsystem 508, other input/control apparatus 509 and an external port 510. These components communicate with each other via one or more communication buses or signal lines 511.

The mobile smart terminal for acquiring vehicle information provided according to the present embodiment will be described in detail as follows.

The memory 501 may be accessed by the CPU 502, the peripheral interface 503, etc. The memory 501 may include a high-speed random access memory and may include non-volatile memory, such as one or more magnetic disk storage devices, flash memory devices, or other volatile solid state storage devices.

The peripheral interface 503 may connect input/output peripherals of the device to the CPU 502 and the memory 501.

The I/O subsystem 508 may connect input/output peripherals of the device, such as a touch screen 512 and other input/control apparatus 509, to the peripheral interface 503. The I/O subsystem 508 may include a display controller 5081 and one or more input controllers 5082 for controlling other input/control apparatus 509. The one or more input controllers 5082 receives an electrical signal from other input/control apparatus 509 or transmits an electrical signal to other input/control apparatus 509. Other input/control apparatus 509 may include a physical button (e.g., a push button, a rocker button, etc.), a dial pad, a slider switch, a joystick, and a click wheel. It should be noted that the input controller 5082 may be connected with any one of a keyboard, an infrared port, a USB interface, and a pointing device such as a mouse.

The touch screen 512 is an input/output interface between the mobile smart terminal and the user, which may display visual output to the user. The visual output may include graphics, text, icons, video and the like.

The display controller 5081 in the I/O subsystem 508 may receive an electrical signal from the touch screen 512 or transmit an electrical signal to the touch screen 512. The touch screen 512 may detect a contact on the touch screen. The display controller 5081 may convert the detected contact into an interaction with a user interface object displayed on the touch screen 512, to achieve human-machine interaction. The user interface object displayed on the touch screen 512 may be an icon to execute a game, or an icon to access a network. It should be noted that, the device may further includes an optical mouse which is a touch-sensitive surface not displaying visual output, or an extension of the touch-sensitive surface formed by the touch screen.

The RF circuit 504 is configured to establish communications between the mobile smart terminal and a wireless network (the network side) thereby achieving data reception and transmission between the mobile smart terminal and the wireless network, such as reception and transmission of a short massage or an e-mail. The RF circuit 504 receives and transmits a RF signal which is also referred to as an electromagnetic signal. The RF circuit 504 converts an electrical signal to an electromagnetic signal or converts an electromagnetic signal to an electrical signal, and communicates with the communication network and other apparatus via the electromagnetic signal. The RF circuit 504 may include a known circuit for implementing such functions, which may include but not limited to an antenna system, an RF transceiver, one or more amplifiers, a tuner, one or more oscillators, a digital signal processor, a CODEC chipset, a subscriber identity module (SIM), etc.

The audio circuit 505 is configured to receive audio data from the peripheral interface 503, convert the audio data into an electrical signal and transmit the electrical signal to the speaker 506.

The speaker 506 is configured to convert a voice signal received by the mobile smart terminal from the wireless network with the RF circuit 504 to a sound and play the sound to the user.

The power management chip 507 is configured to supply power to and perform power management for the CPU 502, the I/O subsystem 508 and hardware connected to the peripheral interface 503.

The CPU 502 in the present embodiment is configured to communicate with the diagnostic device via the WLAN, access the diagnostic device with the webpage and display the vehicle information with the webpage.

In the present embodiment, the CPU 502 is configured to access the diagnostic device by entering an IP address of the diagnostic device in an address bar of a browser on the mobile smart terminal.

A mobile smart terminal in the vehicle information acquisition device is provided according to the embodiment. The mobile smart terminal may communicate with the diagnostic device via the WLAN, and access the diagnostic device via a webpage to obtain the vehicle information displayed on the webpage. Thus, a user may obtain vehicle traveling information in real time by accessing a WLAN network with the mobile smart terminal. As compared with a conventional vehicle information acquisition method, the solutions provided are more convenient in usage and are more widely applicable.

Those skilled in the art can understand that all or a few of the steps of the above embodiment methods may be implemented by signaling related hardware with an program stored in a computer-readable storage medium, such as a read-only storage, magnetic disk, and an optical disk.

The vehicle information acquisition method and the vehicle information acquisition device according to the embodiments of the disclosure have been described in detail above. Specific examples are adopted herein to describe the principle and implementation of the disclosure. The above embodiments are merely intended to facilitate to understand the method and core idea of the disclosure. Modifications may be made to the embodiments and the application scope by those skilled in the art based on the idea of the disclosure. In summary, the content of the specification should not be construed to limit the invention.

1. A vehicle information acquisition method, comprising:
collecting vehicle information by a diagnostic device, wherein the diagnostic device is provided with a wireless local area network WLAN module for transmitting a WLAN signal; and
accessing the diagnostic device by a mobile smart terminal via a webpage, wherein the diagnostic device and the mobile smart terminal are in communication connection via the WLAN, and the vehicle information is displayed on the webpage.

2. The vehicle information acquisition method according to claim 1, wherein, after the collecting vehicle information by a diagnostic device, the method further comprises:
analyzing the vehicle information by the diagnostic device.

3. The vehicle information acquisition method according to claim 1, wherein the collecting vehicle information by a diagnostic device comprises:
reading the vehicle information by a diagnostic device via an on-board diagnostics OBD interface.

4. The vehicle information acquisition method according to claim 3, wherein the vehicle information comprises:
vehicle traveling information and vehicle diagnostic trouble code information.

5. The vehicle information acquisition method according to claim 1, wherein the accessing the diagnostic device by a mobile smart terminal via a webpage comprises:
accessing the diagnostic device by entering an IP address of the diagnostic device in an address bar of a browser on the mobile smart terminal.

6. A vehicle information acquisition device, comprising:
a diagnostic device configured to collect vehicle information, wherein the diagnostic device is provided with a wireless local area network WLAN module for transmitting a WLAN signal; and
a mobile smart terminal in communication connection with the diagnostic device via the WLAN, wherein the mobile smart terminal is configured to access the diagnostic device via a webpage, and the vehicle information is displayed on the webpage.

7. The vehicle information acquisition device according to claim 6, wherein the diagnostic device comprises:
an analyzing unit configured to analyze the collected vehicle information.

8. The vehicle information acquisition device according to claim 6, wherein the diagnostic device is configured to read the vehicle information via an on-board diagnostics OBD interface.

9. The vehicle information acquisition device according to claim 8, wherein the diagnostic device is configured to collect vehicle traveling information and vehicle diagnostic trouble code information.

10. The vehicle information acquisition device according to claim 8, wherein the mobile smart terminal is in communication connection with the diagnostic device via the WLAN, and accesses the diagnostic device by entering an IP address of the diagnostic device in an address bar of a browser on the mobile smart terminal.

11. A mobile smart terminal, comprising:
a memory, a central processing unit, a peripheral interface, an RF circuit, a power management chip, an input/output subsystem, other input/control apparatus and an external port, wherein the foregoing components communicate with each other via one or more communication buses or signal lines;
wherein the central processing unit is in communication connection with the diagnostic device via a wireless local area network WLAN, and accesses the diagnostic device via a webpage, and vehicle information is displayed on the webpage.

12. The mobile smart terminal according to claim 11, wherein the central processing unit is configured to access the diagnostic device by entering an IP address of the diagnostic device into an address bar of a browser on the mobile smart terminal.

13. The vehicle information acquisition method according to claim 2, wherein the collecting vehicle information by a diagnostic device comprises:
reading the vehicle information by a diagnostic device via an on-board diagnostics OBD interface.

14. The vehicle information acquisition method according to claim 13, wherein the vehicle information comprises:
vehicle traveling information and vehicle diagnostic trouble code information.

15. The vehicle information acquisition method according to claim 2, wherein the accessing the diagnostic device by a mobile smart terminal via a webpage comprises:
accessing the diagnostic device by entering an IP address of the diagnostic device in an address bar of a browser on the mobile smart terminal.

16. The vehicle information acquisition device according to claim 7, wherein the diagnostic device is configured to read the vehicle information via an on-board diagnostics OBD interface.

17. The vehicle information acquisition device according to claim 16, wherein the diagnostic device is configured to collect vehicle traveling information and vehicle diagnostic trouble code information.

18. The vehicle information acquisition device according to claim 16, wherein the mobile smart terminal is in communication connection with the diagnostic device via the WLAN, and accesses the diagnostic device by entering an IP address of the diagnostic device in an address bar of a browser on the mobile smart terminal.
